(19) United States
(12) Patent Application Publication
(10) Pub. No.: US 2005/0235472 A1
(43) Pub. Date: Oct. 27, 2005

(54) Method of manufacture of a battery and current collector

(76) Inventor: Joey Jung, Delta (CA)

Correspondence Address: KEVIN J. MCNEELY, ESQ., 5335 WISCONSON AVENUE, NW, SUITE 440, WASHINGTON, DC, 20015, US

(21) Appl. No.: 11/048,104

(22) Filed: Feb. 2, 2005

Related U.S. Application Data
(63) Continuation-in-part of application No. 10/809,791, filed on Mar. 26, 2004.

(51) Int. Cl. B05D 5/12

(52) U.S. Cl. 29/2; 427/123

(57) ABSTRACT

A method of manufacturing a battery and a battery current collector having an electrically conductive substrate that includes a reticulated vitreous carbon plate with a metallic alloy on surfaces of the reticulated vitreous carbon plate includes thermal spray coating the reticulated vitreous carbon plate with the metallic alloy by, for example, plasma spraying.

### CROSS REFERENCE TO RELATED APPLICATIONS

This application is a continuation-in-part of U.S. patent application Ser. No. 10/809,791 filed on Mar. 26, 2004, and claims priority to U.S. Provisional application Ser. No. 60/325,391 filed Sep. 26, 2001.

### FIELD OF THE INVENTION

This invention relates generally to the manufacture of lead-acid batteries and more particularly to the manufacture of high surface area electrodes which improve the performance of lead-acid batteries.

### BACKGROUND OF THE INVENTION

The lead-acid battery in its various configurations is a well known power source for diverse applications such as starting-lighting-ignition (SLI), uninterrupted power supply (UPS) and motive power. Continuous development of new applications, such as, for instance, in the area of electric vehicles and hybrid electric vehicles (EV and HEV), impose challenging performance demands on battery technologies in general and lead acid batteries in particular.

Pavlov summarized the relationship between battery specific energy in watt hours/kilogram (Wh/kg) and number of battery discharge/charge cycles for both flooded and valve-regulated type lead acid batteries. For both battery types, the higher the battery specific energy the lower the number of discharge/charge cycles and hence, the battery cycle life. Typically, a conventional flooded battery with a specific energy of 40 Wh/kg can be used for about 500 discharge/charge cycles, while a conventional battery producing only 30 Wh/kg can be employed for about 850 cycles. Thus, there is a need to improve both the specific energy and cycle life of lead-acid batteries in order to make them more suitable for electric traction applications.

Examples of techniques to increase the efficiency of lead-acid batteries are described in U.S. patent application Ser. No. 10/809,791, which describes use of an electrode having a reticulated carbon structure coated with a metal alloy coating, thereby increasing the surface area of the electrode while maintaining its strength. However, the metallic coating process of the non-metallic substrate can be time intensive, particularly because of the much larger surface area than a conventional metal plate. Thus, a need exists for an improved method of manufacture of a lead-acid battery with electrodes having a reticulated carbon structure coated with a metallic alloy coating.

### SUMMARY OF THE INVENTION

The present invention relates to methods of improving the manufacturing techniques for lead-acid batteries having current collector structures based on light-weight, porous, open pore, high specific surface area (e.g. >500 m²/m³) substrates coated with a lead-tin alloy. More specifically it discloses a thermal spray coating process that reduces the manufacturing time and costs associated with current collectors that use lead-tin alloys deposited on lightweight, open pore substrates such as carbon or aluminum. The present invention also provides methods for producing high-performance current collectors, which includes the steps of lead or lead-alloy deposition and attachment of lugs, tabs and frames to the three-dimensional substrate.

In one general aspect, a method of manufacturing a battery current collector having an electrically conductive substrate that includes a reticulated vitreous carbon plate with a metallic alloy on surfaces of the reticulated vitreous carbon plate includes thermal spray coating the reticulated vitreous carbon plate with the metallic alloy by, for example, plasma spraying.

Embodiments may include one or more of the following features. For example, the method may include carbonizing a polyurethane foam sheet to produce the reticulated vitreous carbon plate. The carbonizing may include passing the polyurethane foam sheet through a paralyzing furnace

The method may also include powderizing the metallic alloy used in the thermal spray coating by, for example, gas atomization. The powderized alloy may be a mixture of lead and tin with 99% lead content and 1% tin content. The powderized alloy may also be a mixture of silver, lead and tin with 98% lead content, 1% tin content, and 1% silver content.

In other embodiments, the method includes additional operations, such as, for example, preheating the reticulated vitreous carbon plate or applying a stabilizing agent to the reticulated vitreous carbon plate.

In another general aspect, a method of manufacturing a battery current collector having an electrically conductive substrate that includes a reticulated vitreous carbon plate coated with a metallic alloy includes carbonizing a polyurethane foam sheet to produce the reticulated vitreous carbon plate, applying a stabilizing agent to the reticulated vitreous carbon plate, powderizing the metallic alloy, injecting the powderized metallic alloy into a plasma flame to produce a stream of molten metallic particles, and spraying the stream of molten particles onto surfaces of the reticulated vitreous carbon plate. Embodiments may include one or more of the features described above.

In a further general aspect, a method of manufacturing a battery with electrodes having reticulated vitreous carbon plates coated with a metallic alloy includes plasma spraying the reticulated vitreous carbon plates with the metallic alloy to produce the current collector, casting a tab and frames on sides of the reticulated vitreous carbon plates, coating the reticulated vitreous carbon plates with an electrically conductive paste, installing the coated reticulated vitreous carbon plates in a battery housing, and filling the battery housing with an electrolyte. Implementations may include one or more of the features described above.

### BRIEF DESCRIPTION OF THE DRAWINGS

FIG. 1A is a front view schematic of the current collector according to one embodiment of the present invention;

FIG. 1B is a front view schematic of the current collector according to another embodiment of the invention;

FIG. 1C is a front view schematic of the current collector according to an alternative embodiment of the invention;

FIG. 2 is a scanning electron microscopy image of the high-specific surface area, reticulated part of the current collector structure according to one embodiment of the invention;

FIG. 3 shows a cross-sectional view, obtained by backscattered electron microscopy of the current collector structure according to the present invention; and

FIG. 4 describes a method of manufacturing a battery and battery current collector of the present invention.

### DETAILED DESCRIPTION

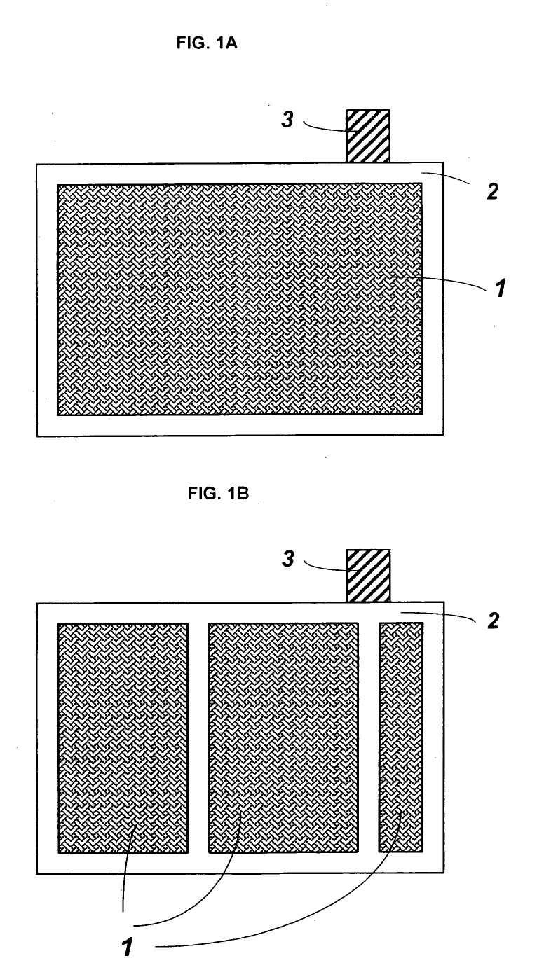

FIG. 1 represents a front view of the current collector structure according to one embodiment of the present-invention. Reference numeral 1 is the high specific surface area part manufactured by depositing lead or lead-alloys on an electrically conductive, reticulated substrate such as, but not limited to, reticulated vitreous carbon. The high specific surface area part is attached to a frame 2, which in turn is connected to a lug 3. Both the frame 2 and the lug 3 are made of lead or a lead-alloy.

In another embodiment, shown by FIG. 1B, the lead or lead-tin alloy deposited reticulated part 1 is compartmentalized by intercalated strips which are part of the overall frame structure 2. The compartmentalization improves the current and potential distribution characteristics across the high specific surface area component of the current collector structure, especially in the case of larger plate designs.

A further design variation is presented by FIG. 1C. The top connector 3 has a triangular design, gradually widening toward the left edge of the collector where a lug 4 is attached to the connector 3. This design feature reduces the weight of the connector 3 while providing good corrosion resistance in the area of highest current concentration, such as, for example, in the current entry and exit zone near the lug 4. The frame 2 around the reticulated structure can be of similar or different width. A wider frame 2 may be used on the side that is in contact with the lug 4 and a thinner frame 2 may be used on the opposite side (FIG. 1C).

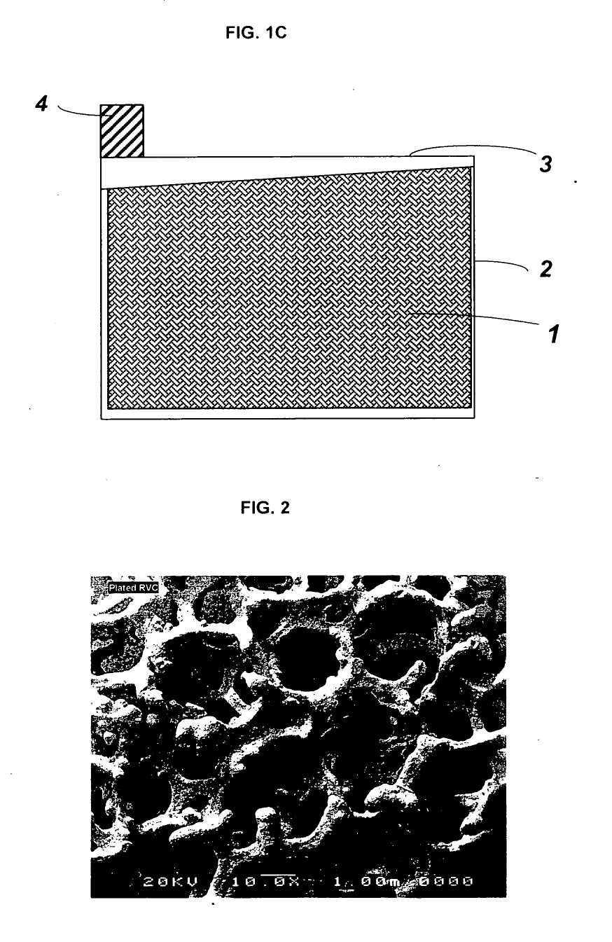

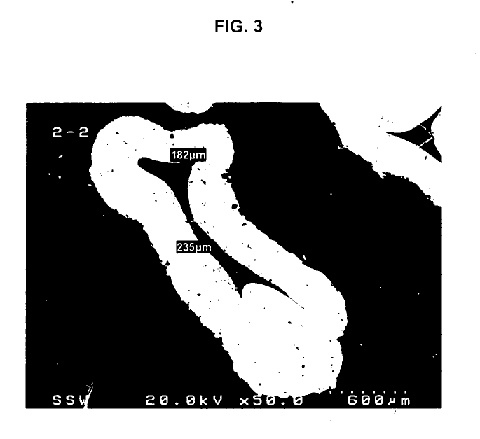

A scanning electron microscopy image and a backscattered electron microscopy image of the reticulated part of the collector is shown in FIG. 2 and a backscattered electron microscopy image of the reticulated part of the collector is shown in FIG. 3. The illustrated reticulated vitreous carbon, which has 30 pores per inch (ppi), serves as the substrate and is plated with a lead alloy to comprise a functional collector for lead-acid batteries. FIG. 2 shows the interconnected, open-cell network, which forms the physical basis for current transfer to and from the active mass. The latter covers the surface of the wires and also occupies the openings of the reticulated structure. The proximity of the current collector wires to the active mass, for example, the diameter of the openings about 2 mm for the case depicted by FIG. 2, leads to enhancement of the active mass utilization efficiency and charge acceptance.

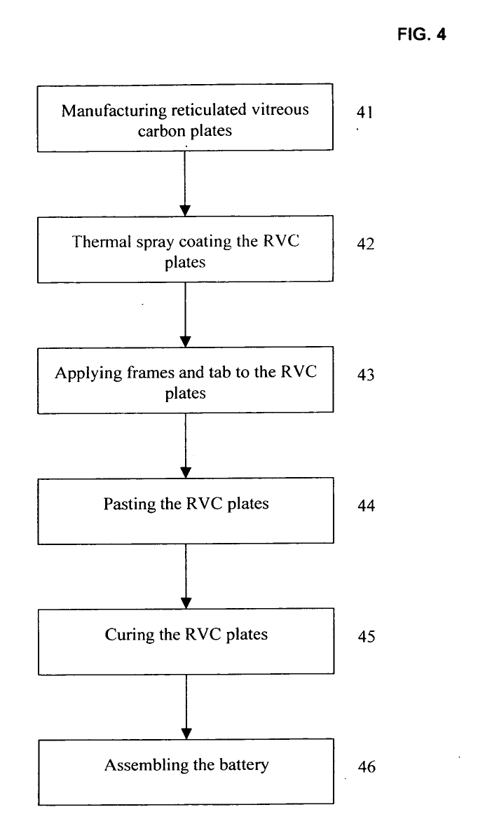

A method of manufacturing a lead-acid battery with a reticulated vitreous carbon (RVC) substrate is shown in FIG. 4. In operation 41, a reticulated vitreous foam sheet with about 20 to 30 pores per inch passes through a paralyzing furnace thereby decomposing the foam into the RVC. A stabilizing agent can then be applied to the RVC.

The RVC sheet is sliced to a thickness of about 3.5 mm, using a steel cutter. After slicing, the height and width of the carbon slab can be adjusted to the size needed for the particular battery. A commonly employed current collector size is 12.7 cm×12.7 cm (height×width).

Following size adjustment, the vitreous carbon substrate is uniformly coated with a layer of lead-tin alloy in operation 42. Traditional coating methods include electroplating and vacuum deposition, which can be time intensive. Other methods, such as, for example, thermal spray coating, can be used to reduce the coating time.

A preferred coating method is a plasma spray process by which the RVC is coated with molten or softened particles that are applied by impact to the RVC substrate. In the plasma spray coating process, the coating material is injected into a very high temperature plasma flame, where it is rapidly heated and accelerated to a high velocity.

The plasma spray gun is typically a water-cooled device with a copper anode and a tungsten cathode. Plasma gas, such as, for example, argon, nitrogen, hydrogen, or helium, flows around the cathode and through the anode, which is shaped as a constricting nozzle. The plasma is initiated by a high voltage discharge which causes ionization and an electrical arc to form between the cathode and anode. The resistance heating from the arc causes the gas to reach extreme temperatures and form a plasma. The plasma exits the anode nozzle as a neutral plasma flame that does not carry an electrical current.

The metallic alloy is powderized by, for example, gas atomization, and is injected or fed into the plasma flame. The powder is rapidly heated to form molten particles and is rapidly accelerated to travel a spray distance of about 25 to 150 millimeters.

The powderized metallic allow may be a mixture of lead and tin, or lead, tin, and silver. In one preferred embodiment, the mixture comprises 98% lead, 1% tin, and 1% silver.

In operation 43, the alloy coated RVC plate is put into a mold and a lead tin alloy is poured into the mold to form a tab and frames on each side. The tab is used to make mechanical and electrical connections with other plates. The two side frames are used to improve current carrying capability. The bottom frame provides structural strength.

In operation 44, the RVC plate is coated with a paste, such as, for example, lead oxide or lead sulfite. In operation 45, the plates are flash dried in an oven and then are stacked in an environment with controlled temperature and humidity. In operation 46, the battery is assembled by installing the plates in a housing and attaching posts and a cover. An electrolyte is then poured into the housing to saturate the plates.

Since certain changes may be made in the above apparatus without departing from, the scope of the invention herein involved, it is intended that all matter contained in the above description or shown in the accompanying drawing shall be interpreted in an illustrative and not in a limiting sense. Accordingly, other implementations are within the scope of the following claims.

1. A method of manufacturing a battery current collector having an electrically conductive substrate that includes a reticulated vitreous carbon plate with a metallic alloy on surfaces of the reticulated vitreous carbon plate, the method comprising:
thermal spray coating the reticulated vitreous carbon plate with the metallic alloy.

2. The method of claim 1, further comprising:
carbonizing a polyurethane foam sheet to produce the reticulated vitreous carbon plate.

3. The method of claim 2, wherein the carbonizing comprises passing the polyurethane foam sheet through a paralyzing furnace

4. The method of claim 1, further comprising:
powderizing the metallic alloy such that the thermal spray coating comprises thermal spray coating the reticulated vitreous carbon plate with the powderized metallic alloy.

5. The method of claim 4, wherein the powderizing comprises gas atomizing the metallic alloy.

6. The method of claim 1, further comprising:
mixing lead and tin to produce the metallic alloy.

7. The method of claim 6, wherein the mixing comprises mixing 99% lead content and 1% tin content to produce the metallic alloy.

8. The method of claim 6, wherein the mixing further comprises mixing silver with the lead and the tin to produce the metallic alloy.

9. The method of claim 8, wherein the mixing comprises mixing 98% lead content, 1% tin content, and 1% silver content to produce the metallic alloy.

10. The method of claim 1, further comprising:
preheating the reticulated vitreous carbon plate.

11. The method of claim 1, further comprising:
applying a stabilizing agent to the reticulated vitreous carbon plate.

12. The method of claim 1, wherein the thermal spray coating comprises plasma spraying.

13. A method of manufacturing a battery current collector having an electrically conductive substrate that includes a reticulated vitreous carbon plate coated with a metallic alloy, the method comprising:
carbonizing a polyurethane foam sheet to produce the reticulated vitreous carbon plate;
applying a stabilizing agent to the reticulated vitreous carbon plate;
powderizing the metallic alloy;
injecting the powderized metallic alloy into a plasma flame to produce a stream of molten particles; and
spraying the stream of molten particles onto surfaces of the reticulated vitreous carbon plate.

14. The method of claim 13, further comprising:
preheating the reticulated vitreous carbon plate.

15. A method of manufacturing a battery with electrodes having reticulated vitreous carbon plates coated with a metallic alloy, the method comprising:
plasma spraying the reticulated vitreous carbon plates with the metallic alloy to produce the current collector;
casting a tab and three frames on sides of the reticulated vitreous carbon plates;
coating the reticulated vitreous carbon plates with an electrically conductive paste;
installing the coated reticulated vitreous carbon plates in a battery housing; and
filling the battery housing with an electrolyte.
